(19) United States
(12) Patent Application Publication
(10) Pub. No.: US 2009/0148929 A1
(43) Pub. Date: Jun. 11, 2009

(54) BIOSTIMULATION AGENT FOR BIOREMEDIATION AND METHODS THEREFOR

(75) Inventors: Raymond J. Tarasi, Pittsburgh, PA (US); Gary W. Dalrymple, Allison Park, PA (US)

Correspondence Address: THE WEBB LAW FIRM, P.C., 700 KOPPERS BUILDING, 436 SEVENTH AVENUE, PITTSBURGH, PA, 15219, US

(73) Assignee: UNIREM, INC., Pittsburgh, PA (US)

(21) Appl. No.: 12/090,927

(22) PCT Filed: Oct. 19, 2006
(86) PCT No.: PCT/US06/41162

§ 371 Date: Apr. 21, 2008

Related U.S. Application Data
(60) Provisional application No. 60/728,590, filed on Oct. 19, 2005.

(51) Int. Cl. A62D 3/02; B29B 9/00

(52) U.S. Cl. 435/262.5; 264/13

(57) ABSTRACT

A biostimulation agent in the form of hollow spheres comprising soy wax or a combination of soy wax and beeswax. The biostimulation agent is capable of providing sufficient nutrients to help maximize biostimulation of indigenous microbes capable of biodegradation of chemical and/or petrochemical spills in the environment. The hollow spheres can be applied by spraying the loose product onto a spill. Alternatively, the hollow spheres are contained within a porous cylinder, bag, or boom that allows a spilled chemical and/or petrochemical to permeate through and contact the spheres.

### BACKGROUND OF THE INVENTION

1. Field of the Invention

The invention relates generally to a biostimulation agent in the nature of spheres comprising soy wax or spheres comprising soy wax and beeswax for use in bioremediation of chemical and/or petrochemical spills in the environment.

2. Description of Related Art

Bioremediation is recognized as one of several effective techniques in certain geographic and climatic conditions to clean up chemical and/or petrochemical spills in the environment. Bioremediation is based upon the use of nutrients to enhance the activity of indigenous organisms and/or the addition of non-indigenous microorganisms to enhance the clean-up of chemical and/or petrochemical spills. The use of bioremediation is a preferred technique for cleaning up spills because it provides the process of naturally converting chemicals and/or petrochemicals into non-toxic by-products without any further local environmental disruption.

Several factors influence the degree of success of bioremediation. The most important factors are the type of indigenous bacteria present at the site of a spill, the physical and chemical characteristics of the chemicals and/or petrochemicals involved in the spill, and the surface area of the spill. Bioremediation presents two main approaches. One approach is bioaugmentation, which is the introduction of bacteria to a spill site to supplement the indigenous microbial population in. digesting the spilled chemicals and/or petrochemicals. The other approach is biostimulation, which is the introduction of nutrients and/or other growth enhancing substances to a spill site to stimulate the growth of indigenous microbes, which digest the spilled chemicals and/or petrochemicals. At least 200 indigenous genera of bacteria are known that are capable of biodegradation of chemicals and/or petrochemicals with the method of the present invention. Genera of known indigenous bacteria include Pseudomonas, Bacillus, Aspirigillas and Arthrobacter. Other suitable genera of indigenous bacteria are capable of biodegrading chemicals and/or petrochemicals with the method of the present invention. See Zobell, C. E.; 1973, “Microbial degradation of oil; present status, problems and perspectives,” pp. 3-15, (D. G. Ahearn and S. P. Meyers, eds.), The microbial degradation of oil pollutants, Center for Wetlands resources, LSU Pub. No. LSU-SG-73-0.

There are several challenges associated with the use of bioaugmentation, which can limit its overall success. The challenges involve the sensitivity of the environment including the inherent difficulties associated with providing an effective microbial population in an environment, carrying capacity of most environments to maintain an effective amount of microbial population, and biodegrading performance of indigenous microbes that tends to damper the activity of the non-indigenous microbes. In comparison, there is generally a single, primary challenge associated with biostimulation. The challenge is to maintain an optimal nutrient concentration in consistent contact with a spilled chemical and/or petrochemical.

There is a two-fold approach for nutrient requirements to support effective biostimulation to cause biodegradation of spilled chemicals and/or petrochemicals with indigenous microbes. The nutrients must remain in contact with the spilled chemical and/or petrochemical and soiled materials. Additionally, the nutrient concentrations must be sufficient to support the maximal growth rate of indigenous microbes functioning to degrade the spilled chemical and/or petrochemical for the duration of the clean-up operation. Maximum biodegradation of spilled chemicals and/or petrochemicals occurs when sufficient concentration levels of nitrogen and phosphorous are maintained at a spill site to stimulate indigenous microbes.

In an attempt to address the primary challenge associated with the biostimulation approach to chemical and/or petrochemical spills in the environment, U.S. Pat. No. 6,699,390, which is incorporated herein by reference, generally teaches the use of beeswax to facilitate the biodegradation of chemicals and/or petrochemicals. The '390 patent specifically teaches the use of natural beeswax as a key operative component. The beeswax is provided as hollow spheres, which are capable of binding, absorbing and containing chemicals and/or petrochemicals. The hollow spheres can be applied as a loose product by spraying the spheres onto the spill. Alternatively, the hollow spheres are contained within a porous cylinder, bag or boom, which allows chemicals and/or petrochemicals to permeate through and contact the spheres. In either case, the beeswax binds with and absorbs the spilled chemical and/or petrochemical to contain the spill in the environment. The beeswax also provides nitrogenous and phosphorous forms of nutrients to promote indigenous microbe biodegradation of the spilled chemicals and/or petrochemicals and the beeswax itself.

Generally, the use of spheres of beeswax to clean up a chemical and/or petrochemical spill is preferable for two primary reasons. The spheres of beeswax are biodegradable, safe, user-friendly and environmentally benign. In particular, the provisions of inherent nutrients with the beeswax helps indigenous microbes to digest and destroy the toxic compounds in the environment, in the absence of collecting and removing a spilled chemical and/or petrochemical from the environment to another location for further processing. The spheres of beeswax are less expensive to manufacture and apply to a spill of a chemical and/or petrochemical in comparison to other forms and methods of spill remediation. Although the manufacture and use of beeswax spheres is cost-effective, it has limitations. The cost for manufacturing the spheres of beeswax is directly related to the fluctuating market price for blocks of beeswax. The market price is linked to the commercial availability of blocks of beeswax, which is available at times in a limited supply.

Accordingly, there is a present need for a biostimulation agent comprised of a material that is less expensive and more readily available than beeswax and that is capable of providing a sufficient level of nutrient concentration for maximizing indigenous microbial biodegradation of chemicals and/or petrochemicals spilled in the environment while being capable of containing the spill.

### SUMMARY OF THE INVENTION

The present invention provides a biostimulation agent and methods therefor, which addresses the problems associated with prior art.

The biostimulation agent is provided in the form of hollow spheres comprising soy wax. The hollow spheres may additionally comprise an amount of beeswax. The hollow spheres are manufactured from commercially available soy wax pellets, which are processed from the plentiful source of soy beans. The cost to purchase soy wax pellets is sufficiently less in comparison to the cost of blocks of beeswax. Additionally, the use of soy-based products is encouraged and provides financial benefits in certain industries, such as the railroad industry. The hollow spheres provide an effective form of a biostimulation agent. In particular, the hollow spheres are capable of providing sufficient nutrients to help maximize biostimulation of indigenous microbes capable of biodegradation of chemical and/or petrochemical spills in the environment.

Methods are provided for manufacturing hollow spheres comprising soy wax or both soy wax and beeswax for biostimulation of indigenous microbes for biodegradation of chemical and/or petrochemical spills in the environment.

Methods are provided for using the hollow spheres for biostimulation of indigenous microbes for biodegrading chemical and/or petrochemical spills in the environment. In accordance with the methods, the hollow spheres can be applied by spraying the loose product onto a spill. Alternatively, the hollow spheres are contained within a porous cylinder, bag or boom that allows a spilled chemical and/or petrochemical to permeate through and contact the spheres. The spheres absorb and contain the spilled chemical and/or petrochemical and also provide nutrients to indigenous microbes, which biodegrade the chemical and/or petrochemical spill and the spheres themselves.

### DESCRIPTION OF THE PREFERRED EMBODIMENTS

The present invention provides a biostimulation agent and methods therefor.

The biostimulation agent is provided in the form of spheres comprising soy wax. The spheres may additionally comprise an amount of beeswax. Generally, the spheres are hollow and, in one embodiment, the spheres have an external diameter in a range between about 0.20 and 1,000 micrometers and, in another embodiment, the spheres have an external diameter between 5 to 50 micrometers. Optionally, the spheres may contain suitable chemical- and/or petrochemical-degrading microbes, such as various species of Pseudomonas or Bacillus, in concentrations of about 5×10⁶ microbes per 200 pounds of wax.

Either the hollow or bacteria-filled form of the spheres can be manufactured by conventional technology known to those skilled in the art. Several prior art devices are suitable for manufacturing the hollow spheres. Suitable devices include the Komfeld Rotary Reactor, a device developed by NASA (see NASA Tech Briefs, MFS-28214, “Rotary Reactor Makes Large Latex Particles”); or through utilization of other encapsulating devices or processes, such as the Vanderhoff Rotary Reactor (also a NASA technology), by microshell manufacturers, e.g., KMS Industries of Ann Arbor, Mich., Picro-Pak, Inc. of N.Y., or Insulated Technologies Corp. of Philadelphia, Pa. The spheres may be made by the method described in U.S. Pat. No. 5,807,724, which is incorporated herein by reference. A method is provided for manufacturing a biostimulation agent in the nature of a sphere comprising soy wax. The method comprises several steps. The first step involves heating soy wax to a temperature above 135° F. and pressurizing the tank to at least 340 psi, wherein the first tank is connected to a brass housing. Optionally, an amount of beeswax can be heated along with the soy wax, creating a homogenous wax mixture. Preferably, the amount of soy wax in the wax mixture is between 50% and 99% of the total weight of the mixture and ideally the amount of soy wax is between 60% and 80%. The second step involves providing a second tank filled with one of the group selected from air, water and solution containing live microbes and nutrients, and pressurizing the tank to at least 300 psi, wherein the second tank is connected to the brass housing. The third step involves spraying the soy wax or wax mixture and one of the group selected from air, water and solution containing live microbes and nutrients through a hypodermic needle with an external orifice connected to the brass housing, wherein the soy wax or wax mixture is sprayed through the external orifice having an internal diameter of at least 12 thousands of an inch, and wherein the one of the group selected from air, water and solution containing live microbes and nutrients is sprayed through the hypodermic needle having an internal diameter of at least 5 thousandths of an inch. The fourth step involves cooling the sprayed soy wax or wax mixture to below 135° F. to form spheres comprising soy wax or wax mixture. The spheres may also be made by other methods known to those skilled in the art.

The economic advantages of substituting some or all of the beeswax for soy wax in the hollow spheres in the present invention are based upon commercially available soy wax pellets, which are derived from the plentiful source of soy beans. Soy wax pellets sell at a market price that is sufficiently less in comparison to the market price of beeswax. At the time of drafting the application, soy wax pellets sold at a market price generally in the range between $0.50 to $1.00 per pound, in comparison to higher priced beeswax sold at a market price generally in the range between $1.50 to $3.00 per pound. The environmental advantages of the hollow spheres comprising soy wax in the present invention are based upon the capability of soy wax to absorb and contain a chemical and/or petrochemical spill in the environment, while also providing sufficient nutrients for maximizing biostimulation of indigenous microbes capable of biodegrading the spilled chemicals and/or petrochemicals.

A series of tests were run to evaluate the capability of soy wax to absorb and biodegrade petrochemical spills. The effectiveness of the soy wax in this capacity was then compared with that of the beeswax bioremediation products known in the art. Water was sampled from a public marina on Lake Erie and transferred to the laboratory where it was dispensed into separate reactors. Each reactor was spiked with diesel so that it contained ˜2650 mg/L of diesel. In accordance with open-sea applications, hollow spheres of either soy wax or beeswax were added to each reactor in sufficient amounts to create a 0.25 inch layer. Over a three week period, the percentage of degradation of the diesel in the reactors was determined by measuring the concentration of certain long chain aliphatic compounds that exist in proportion to the concentration of the diesel. Two controls were used to track the disappearance of contaminant not due to degradation by the soy wax or beeswax additives. The first control tracked abiotic losses due to volatilization. The second control evaluated losses from the indigenous microbes located in Lake Erie. After three weeks, the soy wax product had sorbed and biostimulated the indigenous population to degrade 98.3% of the tracked aliphatic compounds, while the beeswax product had only a slightly better performance of 98.8% biodegradation.

Suitable soy wax used in the manufacture of the spheres must provide nutrients including, but not limited to, nitrogenous and phosphorous forms of nutrients for biostimulation of indigenous microbes. Suitable forms of soy wax can be obtained from any commercially available source. For example, suitable soy wax pellets produced from partially hydrogenated soybean oil are sold by Archer Daniels Midland Co. (ADM), identified by product number 88-583-1. The Product Data Sheet providing partially hydrogenated specifications for soy wax product 88-583-1 is incorporated herein by reference. Other suitable forms of soy wax are known to one skilled in the art.

Methods are provided for using the hollow spheres comprising soy wax or both soy wax and beeswax for biostimulation of indigenous microbes for biodegradation of chemical and/or petrochemical spills in waterway environments. In one embodiment, the method comprises spraying a sufficient amount of loose spheres on a spill in a water environment. In accordance with this method, the spheres float on top of the spill and water, and the spheres bond with the chemicals and/or petrochemicals immediately to prevent the chemicals and/or petrochemicals from sinking into the water. When the spheres become saturated with a chemical and/or petrochemical, the saturated spheres are left at the site of the spill so that the chemical and/or petrochemical can be degraded by indigenous microbes contained in the water. During and after the degradation of the chemicals and/or petrochemicals, the indigenous microbes also degrade the hollow spheres through digestion.

In another embodiment, the method comprises placing a porous cylinder or bag containing the aforementioned spheres on a chemical and/or petrochemical spill in water or in near proximity to the spill to contain the surface spread of the chemical and/or petrochemical. Suitable forms of a porous cylinder or bag are disclosed in U.S. Pat. No. 6,699,390, which is hereby incorporated by reference. The cylinder or bag is comprised of polypropylene or other suitable material, which allows the chemical and/or petrochemical to permeate through the material and to contact the spheres contained within the cylinder or bag.

In yet another embodiment, the method comprises placing a boom containing the spheres comprising soy wax or both soy wax and beeswax on a chemical and/or petrochemical spill in water or in near proximity to the spill to contain the surface spread of the chemical and/or petrochemical. Suitable forms of a boom are disclosed in U.S. Pat. No. 6,699,390. Essentially, the booms are hollow elongated booms 2½ inches in diameter and 10 feet long, and are jointed together to confine and treat small spills. The booms are made of a porous polypropylene and are filled with spheres comprising soy wax. The porous polypropylene does not absorb chemicals and/or petrochemicals but allows for the chemicals and/or petrochemicals to permeate into the interior of the boom where they contact the spheres contained therein.

In any of the aforementioned embodiments of the method of biostimulation, once the chemicals and/or petrochemicals permeate through the material comprising the cylinder, bag or boom, the spheres contained within the cylinder, bag or boom immediately absorb the chemical and/or petrochemical. Optional floatation devices may be used in concert with the cylinders, bags or booms to keep them afloat. When the spheres in a cylinder, bag or boom become saturated with a chemical and/or petrochemical, the saturated spheres are left at the site of the spill so that indigenous microbes in the water can digest the chemicals and/or petrochemicals. During and after degrading the chemicals and/or petrochemicals, the indigenous microbes also degrade the wax by digestion, and the cylinders, bags or booms are then removed from the water. The mechanism of biodegradation is the same as that described above for the loose spheres.

Methods are provided for using the hollow spheres comprising soy wax or both soy wax and beeswax for biostimulation of indigenous microbes to biodegrade chemical and/or petrochemical spills in a bilge of a boat. A porous cylindrically-shaped sock about three inches in diameter and ten inches long is used to keep the bilge of a boat free of chemicals and/or petrochemicals, odor and fumes so that only chemical- and/or petrochemical-free water is pumped overboard. Suitable forms of a sock are disclosed in U.S. Pat. No. 6,699,390. The sock is made of a chemical- and/or petrochemical-permeable material such as a porous-weave polypropylene and contains about eight ounces of the spheres. After coming in contact with a chemical and/or petrochemical, the sock immediately absorbs up to one pound of contaminant, and the spheres absorb the chemical and/or petrochemical for subsequent degradation by indigenous microbes. The microbes degrade the chemical and/or petrochemical over time, and can last an entire boating season. The mechanism of biodegradation is the same as that described above for the loose spheres.

Methods are provided for using the hollow spheres comprising soy wax or both soy wax and beeswax for biostimulation of indigenous microbes for bioremediation of chemical and/or petrochemical spills in the ground. In one embodiment, the method comprises spraying a sufficient amount of loose spheres on a chemical and/or petrochemical spill in an area of ground in the environment. In accordance with this embodiment, the spheres lay on top of the ground where the chemical and/or petrochemical spilled, and the spheres absorb the spilled chemical and/or petrochemical. When the spheres become saturated with a chemical and/or petrochemical, the saturated spheres are left at the site of the spill so that the spilled chemical and/or petrochemical can be degraded by indigenous microbes contained in the ground. During and after the chemical and/or petrochemical degradation, the indigenous microbes also degrade the wax by digestion. Ground contamination can entail seepage of chemical and/or petrochemical into the soil at various depths. After an initial treatment with the spheres, the remediated soil can be removed to expose deeper, contaminated soil. More spheres can be sprayed on the deeper contaminated soil to allow indigenous microbes to degrade the chemical and/or petrochemical spill and the spheres. The multiple steps of cleaning chemical and/or petrochemical spills deep into the ground are known to one skilled in the art. In another embodiment, the method comprises placing a porous cylinder or bag containing the spheres on a chemical and/or petrochemical spill in the ground to absorb the spilled chemical and/or petrochemical and to contain the further spread of the chemical and/or petrochemical on the surface of the ground. The mechanism of absorbing, containing and digesting the spilled chemical and/or petrochemical is the same as that described above for the use of porous cylinders or bags used in application for spills in the water environment.

A series of field tests were run to evaluate the capacity of hollow spheres comprising a mixture of soy wax and beeswax to absorb and biodegrade petrochemical spills. In the first test, three BioSoks™, porous cylindrically-shaped socks commercially available from Universal Remediation, Inc., and two four-foot BioBooms™, hollow elongated booms also commercially available from Universal Remediation, Inc., were placed at various positions throughout the bilge of a boat floating on the Ohio River in Pittsburgh, Pa. Each BioSok™ or BioBoom™ contained the hollow spheres of the instant invention comprised of 60% soy wax and 40% beeswax. The bilge contained water, diesel fuel, and engine oil. After a test period of 30 days, the water in the bilge was visibly clean and the smell of diesel fuel and engine oil was absent. Approximately 60% of the hollow spheres had been degraded. A second test was run where four BioSoks™ and two four-foot BioBooms™, each containing the hollow spheres of the instant invention comprised of 60% soy wax and 40% beeswax, were placed in the bilge a second boat, also floating on the Ohio River in Pittsburgh, Pennsylvania. The bilge of this boat contained water, diesel fuel, and engine oil. After a 30 day test period, the water in the bilge was visibly clean and the odor of diesel fuel and engine oil had disappeared. Approximately 60% of the hollow spheres had been degraded. In the third test, a three-inch by ten-foot BioBoom™ was placed in the Ohio River and attached to a docking pier to collect unburned diesel fuel from the vessel's exhaust, which is the cause of “oil sheen” on the water. Contained within the BioBoom™ were the hollow spheres of the instant invention comprised of 60% soy wax and 40% beeswax. After a one month testing period, approximately 75% of the hollow spheres contained within the BioBoom™ had been degraded. Verbal testimony from the vessel operators state that the product tested absorbs and is degraded at approximately the same rate as the BioBoom™ previously used which contained hollow spheres consisting of beeswax alone. These tests show that the absorption and remediation using a mixture of soy wax and beeswax is equal to the performance of a product using 100% beeswax in identical operations.

While the present invention is satisfied by embodiments in many different forms, there is described herein in detail the preferred embodiments of the invention, with the understanding that the present disclosure is to be considered as exemplary of the principles of the invention and is not intended to limit the invention to the embodiments illustrated. Various other embodiments will be apparent to and readily made by those skilled in the art without departing from the scope and spirit of the invention. The scope of the invention will be measured by the appended claims and their equivalents.

The invention claimed is:

1. A method of bioremediation of a chemical and/or petrochemical spill in the environment, the steps of the method comprising:
a) providing microbial nutrients in the form of spheres comprising soy wax;
b) contacting the spheres with the chemical and/or petrochemical spill; and
c) allowing time to pass for indigenous microbes to degrade the chemical and/or petrochemical and the spheres, wherein the remediation of the chemical and/or petrochemical spill results over a period of time.

2. A method of bioremediation of a chemical and/or petrochemical spill in the environment, the steps of the method consisting essentially of providing microbial nutrients in the form of spheres comprising soy wax and beeswax, contacting the spheres with the chemical and/or petrochemical spill, and allowing time to pass for indigenous microbes to degrade the chemical and/or petrochemical and the spheres, wherein the remediation of the chemical and/or petrochemical spill results over a period of time.

3. A method of bioremediation of a chemical and/or petrochemical spill in the environment, the steps of the method consisting essentially of:
a) providing spheres comprising soy wax;
b) contacting the spheres with the chemical and/or petrochemical spill in the environment;
c) allowing time to pass for the spheres to absorb at least part of the chemical and/or petrochemical spill, wherein the spheres provide microbial nutrients; and
d) allowing further time to pass for indigenous microbes to use the nutrients provided by the spheres to digest the chemical and/or petrochemical and spheres.

4. A method of bioremediation of a chemical and/or petrochemical spill in the environment, the steps of the method consisting essentially of:
a) providing spheres comprising soy wax and beeswax;
b) contacting the spheres with the chemical and/or petrochemical spill in the environment;
c) allowing time to pass for the spheres to absorb at least part of the chemical and/or petrochemical spill, wherein the spheres provide microbial nutrients; and
d) allowing further time to pass for indigenous microbes to use the nutrients provided by the spheres to digest the chemical and/or petrochemical and spheres.

5. A biostimulation agent comprising a sphere comprising soy wax.

6. A biostimulation agent comprising a sphere comprising soy wax and beeswax.

7. A method of manufacturing a biostimulation agent in the nature of a sphere comprising soy wax, the method comprising the steps of:
a) heating soy wax to a temperature above 135° F. in a first tank and pressurizing the tank to at least 340 psi, wherein the first tank is connected to a brass housing;
b) providing a second tank filled with one of the group selected from air, water and solution containing live microbes and nutrients, and pressurizing the tank to 300 psi, wherein the second tank is connected to the brass housing;
c) spraying soy wax and one of the group selected from air, water and solution containing live microbes and nutrients through a hypodermic needle with an external orifice connected to the brass housing, wherein the soy wax is sprayed through the external orifice having an internal diameter of 12 thousands of an inch, and wherein the one of the group selected from air, water and solution containing live microbes and nutrients is sprayed through the hypodermic needle having an internal diameter of 5 thousandths of an inch; and
d) cooling the sprayed soy wax to below 135° F. to form spheres comprising soy wax.

8. A method of manufacturing a biostimulation agent in the nature of a sphere comprising soy wax and beeswax, the method comprising the steps of:
a) heating soy wax and beeswax to a temperature above 135° F. in a first tank creating a homogeneous wax mixture and pressurizing the tank to at least 340 psi, wherein the first tank is connected to a brass housing;
b) providing a second tank filled with one of the group selected from air, water and solution containing live microbes and nutrients, and pressurizing the tank to 300 psi, wherein the second tank is connected to the brass housing;
c) spraying the wax mixture and one of the group selected from air, water and solution containing live microbes and nutrients through a hypodermic needle with an external orifice connected to the brass housing, wherein the wax mixture is sprayed through the external orifice having an internal diameter of 12 thousands of an inch, and wherein the one of the group selected from air, water and solution containing live microbes and nutrients is sprayed through the hypodermic needle having an internal diameter of 5 thousandths of an inch; and
d) cooling the sprayed wax mixture to below 135° F. to form spheres comprising soy wax and beeswax.

9. A method of bioremediation of a chemical and/or petrochemical spill in the environment, the steps of the method consisting essentially of:
a) providing a porous container made of a material which is nonabsorbing to the chemical and/or petrochemical with said container housing hollow spheres comprising soy wax;
b) contacting said container with the spill whereby said chemical and/or petrochemical comes in contact with said hollow spheres; and
c) allowing time to pass for indigenous microbes to degrade the chemical and/or petrochemical and the spheres, wherein the remediation of the chemical and/or petrochemical spill results over a period of time.

10. The method of claim 9 which is carried out in the bilge of a boat.

11. The method of claim 9 in which the container consists essentially of a plastic.

12. The method of claim 9 in which the hollow spheres comprise soy wax and beeswax.

13. A method of bioremediation of a chemical and/or petrochemical spill in the environment, the steps of the method consisting essentially of:
a) providing a plurality of porous containers made of a material which is nonabsorbing to the chemical and/or petrochemical, said container being in the shape of an elongated boom with said container housing hollow spheres comprising soy wax;
b) connecting said booms to confine the spill on water whereby said chemical and/or petrochemical comes in contact with said spheres contained within said booms; and
c) allowing time to pass for indigenous microbes to degrade the chemical and/or petrochemical and the spheres, wherein the remediation of the chemical and/or petrochemical spill results over a period of time.

14. The method of claim 13 in which the boom consists essentially of a plastic.

15. The method of claim 13 in which the hollow spheres comprise soy wax and beeswax.

16. A method of bioremediation of a chemical and/or petrochemical spill on the ground, the steps of the method consisting essentially of:
a) providing spheres comprising soy wax;
b) contacting the spheres with the chemical and/or petrochemical spill on the ground;
c) allowing time to pass for the spheres to absorb at least part of the chemical and/or petrochemical spill, wherein the spheres provide microbial nutrients;
d) exposing a deeper level of soil into which the chemical and/or petrochemical has seeped;
e) providing additional spheres comprising soy wax;
f) contacting such additional spheres with the deeper level of soil;
g) allowing additional time to pass for the additional spheres to absorb at least part of the chemical and/or petrochemical spill, wherein the additional spheres provide microbial nutrients; and
h) allowing still further time to pass for indigenous microbes to use the nutrients provided by the spheres and the additional spheres to digest the chemical and/or petrochemical, the spheres, and the additional spheres.

17. The method of claim 16 in which the spheres comprise soy wax and beeswax.
